(19) United States
(12) Patent Application Publication
(10) Pub. No.: US 2016/0327339 A1
(43) Pub. Date: Nov. 10, 2016

(54) FOAMING PAPER CUP HEATING STRUCTURE

(71) Applicant: Pei-Ti Lin, Taipei (TW)

(72) Inventor: Pei-Ti Lin, Taipei (TW)

(21) Appl. No.: 14/706,075

(22) Filed: May 7, 2015

(51) Int. Cl. F27D 5/00; F27D 11/00

(52) U.S. Cl. CPC F27D 5/0056; F27D 5/0068; F27D 11/00

(57) ABSTRACT

A foaming paper cup heating structure is disclosed, which comprises a heating mechanism, comprising a cavity, and a plurality of heating units disposed within the cavity; and a pick-up and place mechanism, disposed corresponding to the heating units within the cavity. As such, a pick-up and place mechanism is used to grip a plurality of paper cups coated a foaming material thereon, the foaming material is continuously heated within the heating mechanism to foam to present a form, so that the paper cup may achieve the efficacies of a rapid heating, a uniform heating, a rapid producing, and an enhanced production yield.

### FIELD OF THE INVENTION

The present invention relates to a foaming paper cup heating structure, and particularly to such heating structure where a pick-up and place mechanism is used to grip a plurality of paper cups coated a foaming material thereon, the foaming material is continuously heated within the heating mechanism to foam to present a form, so that the paper cup may achieve the efficacies of a rapid heating, a uniform heating, a rapid producing, and an enhanced production yield.

### DESCRIPTION OF THE RELATED ART

In producing a conventional foaming paper cup, PU, PE, PLA are coated on a surface of a container as a foaming material. Next, the container and the foaming material are placed on a microwave oven or a furnace for heating, so that the foaming material forms on the paper cup surface a foaming layer.

However, only the paper cup having the foaming material thereon is placed on the microwave oven or furnace for heating, lending often to a simultaneous heating on the inner and outer sides of the paper cup more than the foaming material being only required to have the heating. In the time, the container and the foaming material absorb the heat energy produced in the course of baking, resulting in that the heating time and temperature may not be heated and, more than that, a wasted energy consumption may occur due to the absorbed heat on the container and the foaming material. In addition, a poor foaming effect may also present, or the inner layer on the paper cup may peel off, causing a lower production yield.

To overcome the shortcomings, the inventor of the present invention sets forth a foaming paper cup heating structure after years of research.

### SUMMARY OF THE INVENTION

It is, therefore, an object to provide a foaming paper cup heating structure, where a pick-up and place mechanism is used to grip a plurality of paper cups coated a foaming material thereon, the foaming material is continuously heated within the heating mechanism to foam to present a form, so that the paper cup may achieve the efficacies of a rapid heating, a uniform heating, a rapid producing, and an enhanced production yield.

According to the present invention, the foaming paper cup heating structure comprises a heating mechanism, comprising a cavity, and a plurality of heating units disposed within the cavity; and a pick-up and place mechanism, disposed corresponding to the heating units within the cavity.

In an embodiment, the plurality of heating units are each fixed on a bottom face and a side face of the cavity.

In an embodiment, each of the plurality of heating units is movably disposed in coordination with a transmission unit on the bottom face and the side face of the cavity.

In an embodiment, each of the plurality of heating units is a heating means selected from a group consisting of an air heater, an infrared, and an electric heating tube.

In an embodiment, the pick-up and place mechanism comprises a plurality of grip devices and a driving unit driving the plurality of grip devices to move, the plurality of grip devices are rotatable to increase a uniform heating temperature or exempted from being rotated.

In an embodiment, a cooler is further disposed on each of the plurality of grip devices, respectively.

### BRIEF DESCRIPTIONS OF THE DRAWINGS

The present invention will be better understood from the following detailed descriptions of the preferred embodiments according to the present invention, taken in conjunction with the accompanying drawings, in which:

FIG. 1 is a schematic diagram of a side view according to a first embodiment of the present invention;

FIG. 2 is a schematic diagram of a top view of a heating mechanism according to the first embodiment of the present invention;

FIG. 3 is a schematic diagram of a use state according to the first embodiment of the present invention;

FIG. 4 is a schematic diagram of the use state according to a second embodiment of the present invention; and

FIG. 5 is a schematic diagram of the use state according to a third embodiment of the present invention.

heating mechanism 1
cavity 11
heating unit 12
transmission unit 13
pick-up and place mechanism 2
gripping device 21
cooler 211
driving unit 22
paper cup 3
foaming material 31

### DESCRIPTION OF THE PREFERRED EMBODIMENTS

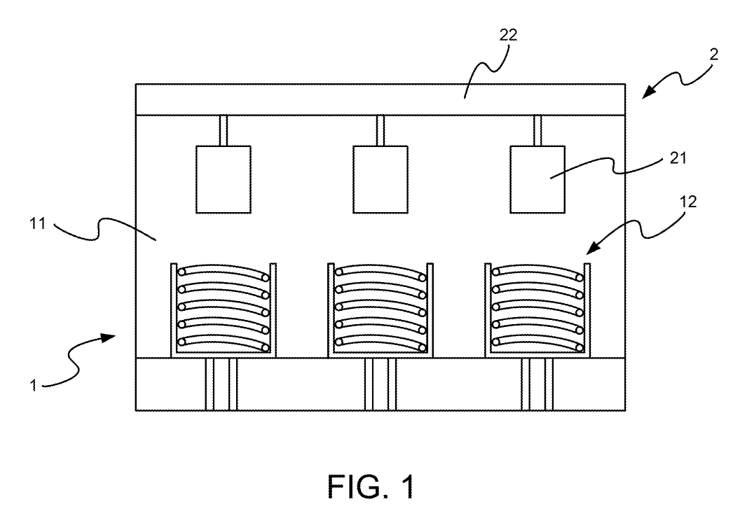

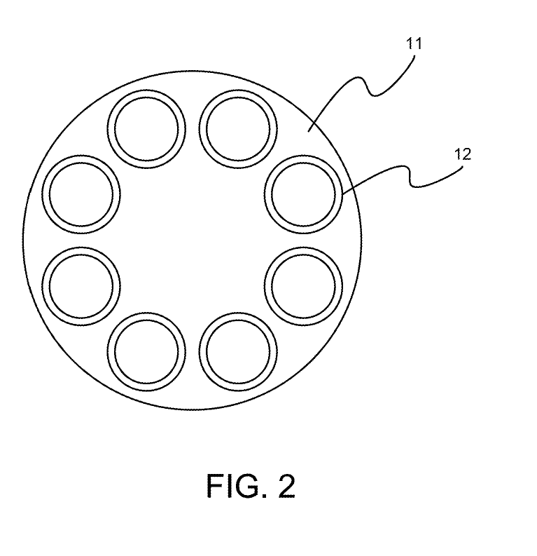

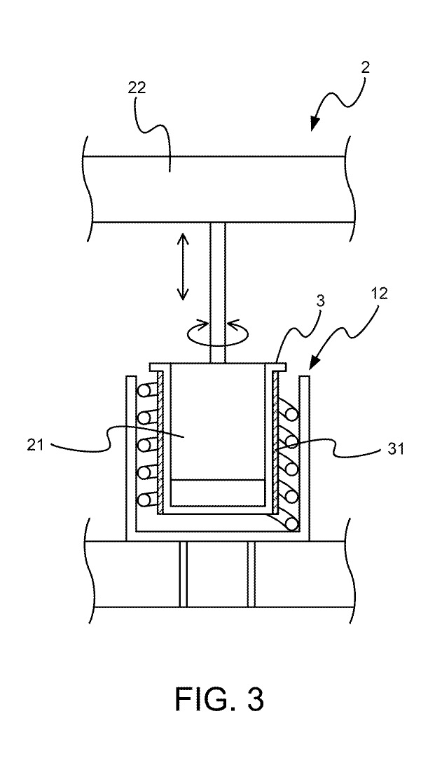

Referring to FIG. 1, FIG. 2, and FIG. 3, a schematic diagram of a side view according to a first embodiment of the present invention; a schematic diagram of a top view of a heating mechanism according to the first embodiment of the present invention, a schematic diagram of a use state according to the first embodiment of the present invention, are shown therein, respectively. As shown, the present invention is a foaming paper cup heating structure, which comprises a heating mechanism 1 and a pick-up and place mechanism 2.

The heating mechanism 1 comprises a cavity 11 and a plurality of heating units 12 disposed within the cavity 11. The heating units 12 are fixed onto a bottom face and a side face of the cavity 11. The heating units 12 are each an air heater, an infrared, and an electric heating tube.

The pick-up and place mechanism 2 is movably disposed corresponding to each of the heating units 12 within the cavity 11 of the heating mechanism 1. The pick-up and place mechanism 2 comprises a plurality of gripping devices 21 and a driving unit 22 for driving the gripping devices 21 to be conveyed. The gripping devices 21 may be rotated to increase a heating uniformity. As such, a novel foaming paper cup is constituted.

When the present invention is operated, each of the gripping devices 21 is used to pick up a paper cup 3 having a foaming material coated thereon, and move the paper cup 3 to the cavity 11 of the heating mechanism 1. Within the cavity 11, the paper cup 3 is heated continuously by the heating units 12, so that the foaming material 31 on the outer surface of the paper cup 3 is heated to present a form. Further, the driving unit 22 is used in the heating process to cause the gripping devices 21 to rotated correspondingly. In this manner, each of the paper cups 3 are enabled to rotate correspondingly, so that the paper cup 3 may achieve the efficacies of a rapid heating (the heating time may be controlled within 4 seconds), a uniform I, a rapid producing, and an enhanced production yield.

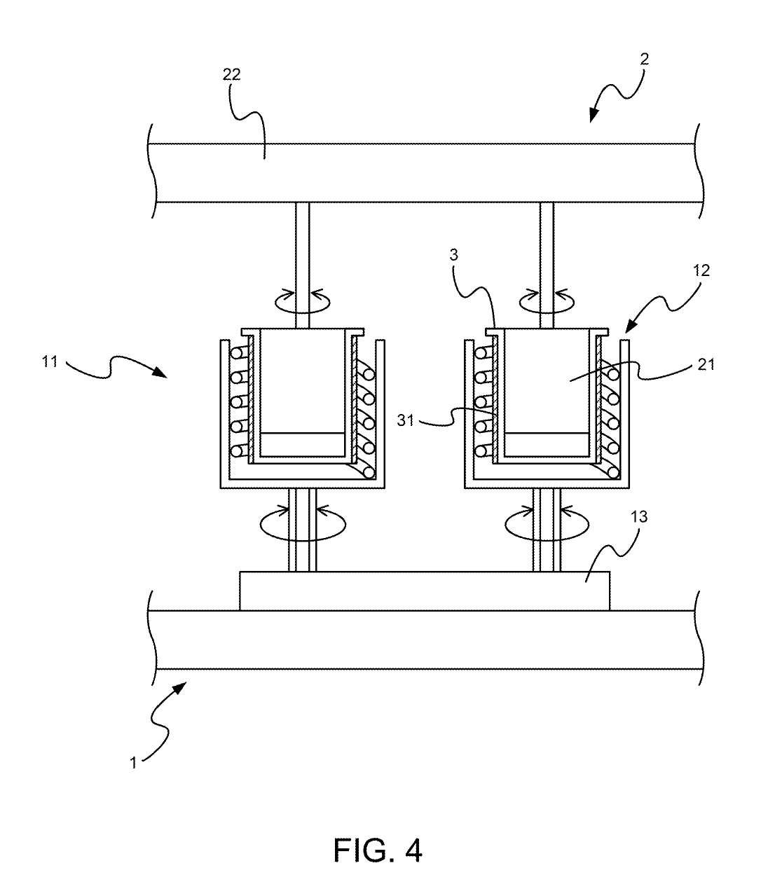

Referring to FIG. 4, a schematic diagram of the use state according to a second embodiment of the present invention is shown therein. The second embodiment has its structure different from the first embodiment that each of the heating units 12 is further movably disposed in coordination with a transmission unit 13 on the bottom face and side face of the cavity 11.

In operation, each of the gripping devices 21 is used to grip the paper cup 3 having the foaming material 21 coated thereon, and each of heating units 12 within the cavity 11 of the heating mechanism 1. In this manner, the foaming material 31 on the outer layer of paper cup 3 to be heated to present a form.

Further, the transmission unit 13 and the driving unit 22 are, in the heating process, operated in coordination with each other to enable each of the heating units 12 and the gripping device 21 to rotate, so that the present invention may further satisfy the requirement in an actual use.

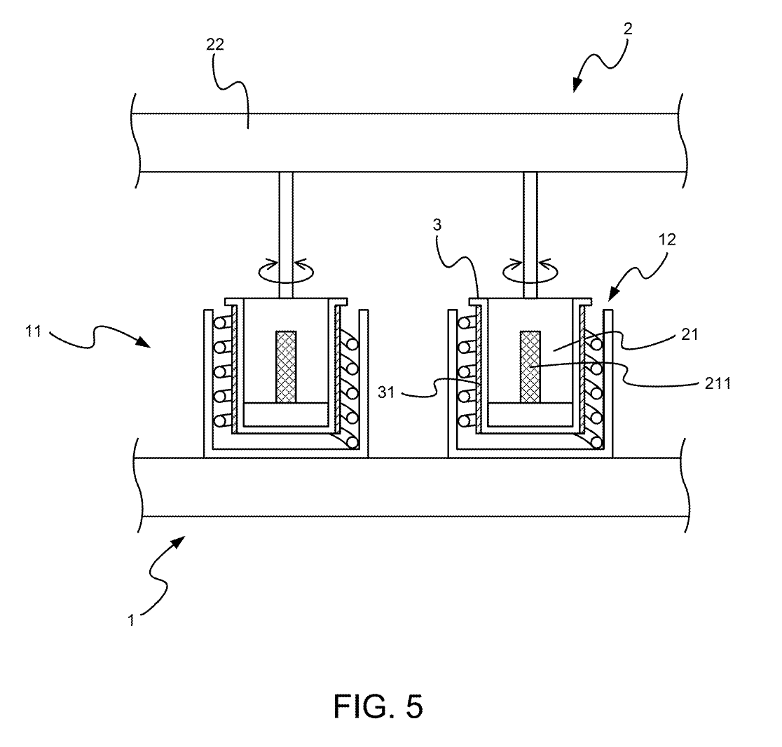

Referring to FIG. 5, a schematic diagram of the use state according to a third embodiment of the present invention is shown therein.

As shown, the structure in the third embodiment has the difference as compared to the first and second embodiments that each of the gripping devices 21 may be further disposed with a cooler 211 thereinside.

In operation, each of the gripping devices 21 of the pick-up and place mechanism 2 is used to grip the paper cup 3 having the foaming material 31 coated thereon, and each of heating units 12 within the cavity 11 of the heating mechanism 1. In this manner, the foaming material 31 on the outer layer of paper cup 3 to be heated to present a form. Further, the driving unit 22 is used to cause each of the gripping devices 21 to rotate in the heating process, and which may enable each of the paper cups 3 to rotate correspondingly. At the same time, the cooler 211 is used to cool inside the paper cup 3. As such, the present invention may further satisfy the requirements of an actual use.

In summary, the foaming paper cup heating structure of the present invention may effectively overcome the shortcomings encountered in the prior art, where the pick-up and place mechanism is used to grip the plurality of paper cups coated the foaming material thereon, the foaming material is continuously heated within the heating mechanism to foam to present a form, so that the paper cup may achieve the efficacies of a rapid heating, a uniform heating, a rapid producing, and an enhanced production yield.

From all these views, the present invention may be deemed as being more effective, practical, useful for the consumer's demand, and thus may meet with the requirements for a patent.

The above described is merely examples and preferred embodiments of the present invention, and not exemplified to intend to limit the present invention. Any modifications and changes without departing from the scope of the spirit of the present invention are deemed as within the scope of the present invention. The scope of the present invention is to be interpreted with the scope as defined in the claims.

What is claimed is:

1. A foaming paper cup heating structure, comprising:
a heating mechanism, comprising a cavity, and a plurality of heating units disposed within the cavity; and
a pick-up and place mechanism, disposed corresponding to the heating units within the cavity.

2. The foaming paper cup heating structure as claimed in claim 1, wherein the plurality of heating units are each fixed on a bottom face and a side face of the cavity.

3. The foaming paper cup heating structure as claimed in claim 2, wherein each of the plurality of heating units is movably disposed in coordination with a transmission unit on the bottom face and the side face of the cavity.

4. The foaming paper cup heating structure as claimed in claim 2, wherein each of the plurality of heating units is a heating means selected from a group consisting of an air heater, an infrared, and an electric heating tube.

5. The foaming paper cup heating structure as claimed in claim 2, wherein the pick-up and place mechanism comprises a plurality of grip devices and a driving unit driving the plurality of grip devices to move, the plurality of grip devices are rotatable to increase a uniform heating temperature or exempted from being rotated.

6. The foaming paper cup heating structure as claimed in claim 5, wherein a cooler is further disposed on each of the plurality of grip devices, respectively.
